(19) United States
(12) Patent Application Publication
(10) Pub. No.: US 2012/0306596 A1
(43) Pub. Date: Dec. 6, 2012

(54) Microwave Filter

(75) Inventor: John David Rhodes, Menston (GB)

(73) Assignee: ISOTEK ELECTRONICS LIMITED, Leeds (GB)

(21) Appl. No.: 13/150,966

(22) Filed: Jun. 1, 2011

(51) Int. Cl. H01P 1/20

(52) U.S. Cl. 333/202

(57) ABSTRACT

A microwave filter for filtering a microwave signal is disclosed. The microwave filter has at least one band edge at a band edge transition frequency. The filter comprises an input port and an output port. The filter also comprises a plurality of single resonators connected in parallel between the input and output ports. The filter further comprises a frequency independent electrical coupling between the input and output ports connected in parallel with the resonators. A subset of the resonators has Q values each of which are at least a factor of three higher than the Qs of each of the remaining resonators.

The present invention relates to a microwave filter. More particularly, but not exclusively, the present invention relates to a microwave filter comprising a plurality of single resonators and a frequency independent coupling connected in parallel between input and output ports, a subset of the resonators having Q factors which are sufficiently higher than that of the remaining resonators to achieve low loss across the entire passband.

All passive resonators have a finite unloaded Q factor. In narrow bandwidth applications this resistive loss can lead to difficulties in the design process. In a bandpass application, designs which provide for both a good input and output match will exhibit transfer characteristics with significant amplitude and variation over the passband if mid band loss is minimised. This passband variation can only be reduced with given Q factors if the mid band loss is increased possibly to an unacceptable level. Even in the case of a single resonator filter, problems occur due to the resistive loss which prevents a good input and output match being simultaneously achievable.

In the case of a rapid transition from a passband to a stopband the resistive loss of the resonators causes a roll off in the insertion loss into the passband. A reduction in unloaded Q can quickly cause this loss to reach an unacceptable level particularly where noise figure is important and the filter has been introduced to reject signals which would limit the dynamic range of the receiver.

In conventional filters, each resonator couples loss into the system. To meet typical requirements at least 25 dB rejection has to be provided over a band in excess of several MHz whilst the loss at 0.5 MHz into the passband has to be less than 0.5 dB. To achieve this unloaded Qs of greater than 20,000 are required resulting in the necessity, at microwave frequencies, to use ceramic resonators for all of the cavities resulting in a physically large, heavy and expensive filter.

The filter according to the invention seeks to overcome the problems of the prior art.

Accordingly, the present invention provides a microwave filter for filtering a microwave signal, the microwave filter having at least one band edge at a band edge transition frequency, the filter comprising

an input port;
an output port; and,
a plurality of single resonators connected in parallel between the input and output ports;
the filter further comprising a frequency independent electrical coupling between input and output ports connected in parallel with the resonators;
a subset of the resonators having Q values each of which are at least a factor of three higher than the Qs of each of the remaining resonators.

The microwave filter according to the invention requires only one high Q resonator per band edge to achieve low loss across the entire filter passband.

Preferably, the number of resonators in the subset is equal to the number of band edges.

Preferably, the Q values of the resonators in the subset are at least four times, more preferably five times that of the Qs of each of the remaining resonators.

The filter can have only one band edge.

The filter may consist of two resonators in parallel.

The filter may comprise at least three, preferably four resonators in parallel.

Preferably, at least one resonator comprises a cavity resonator.

The filter may comprise at least one impendence inverter.

The filter may further comprise an electrical signal generator connected to the input port of the filter.

The present invention will now be described by way of example only and not in any limitative sense with reference to the accompanying drawings in which

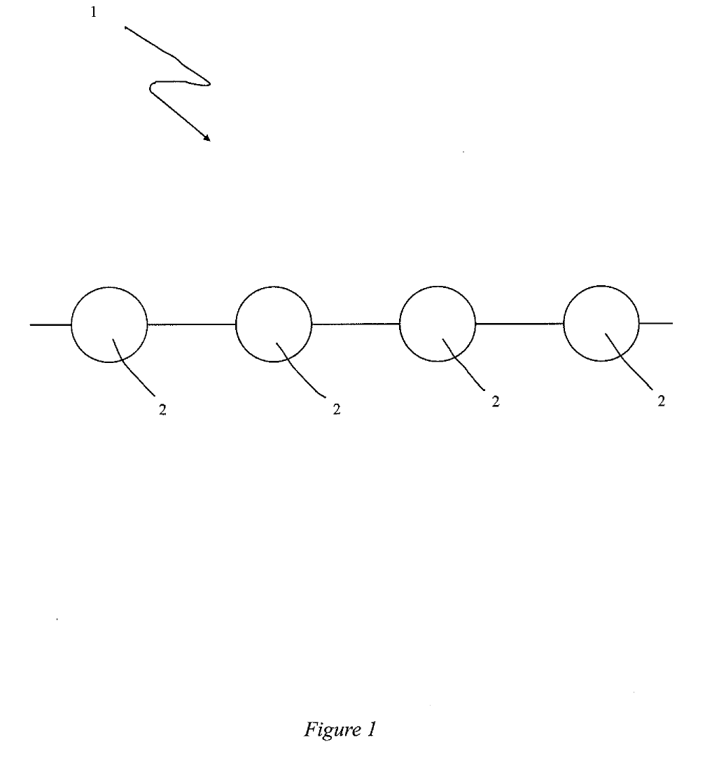

FIG. 1 shows a known microwave filter;

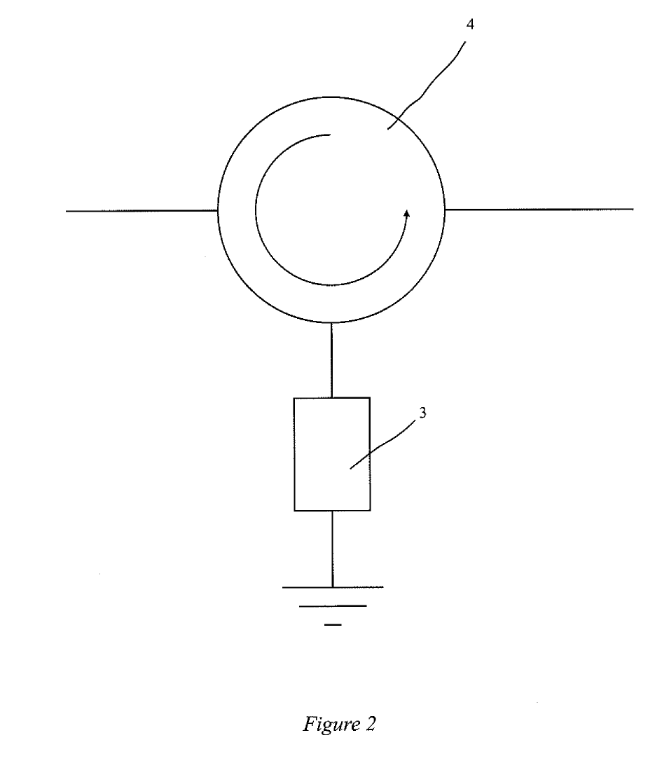

FIG. 2 shows a further known microwave filter;

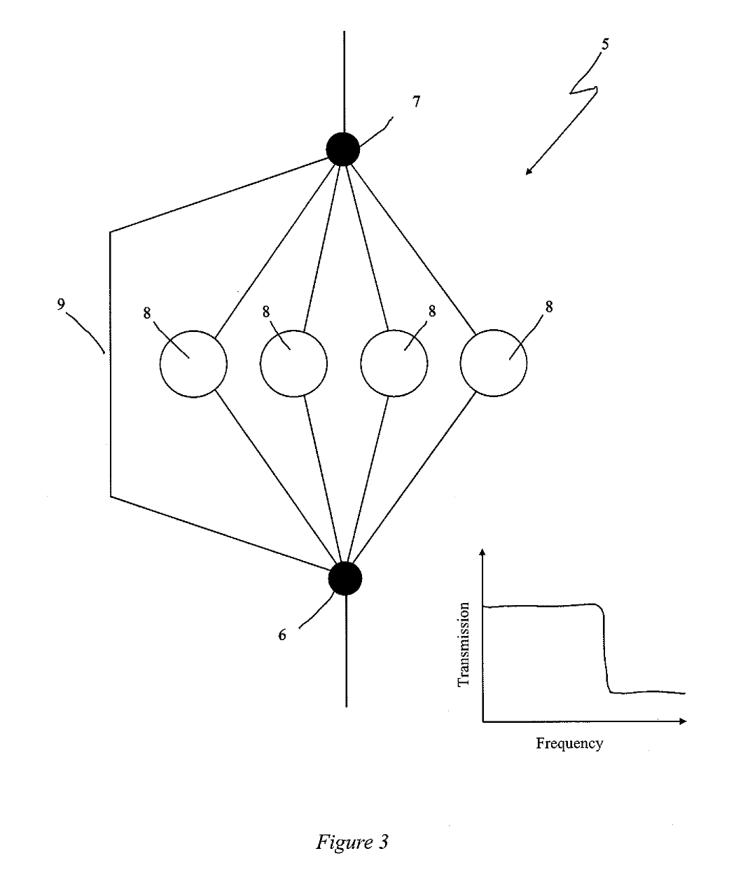

FIG. 3 shows an embodiment of a filter according to the invention;

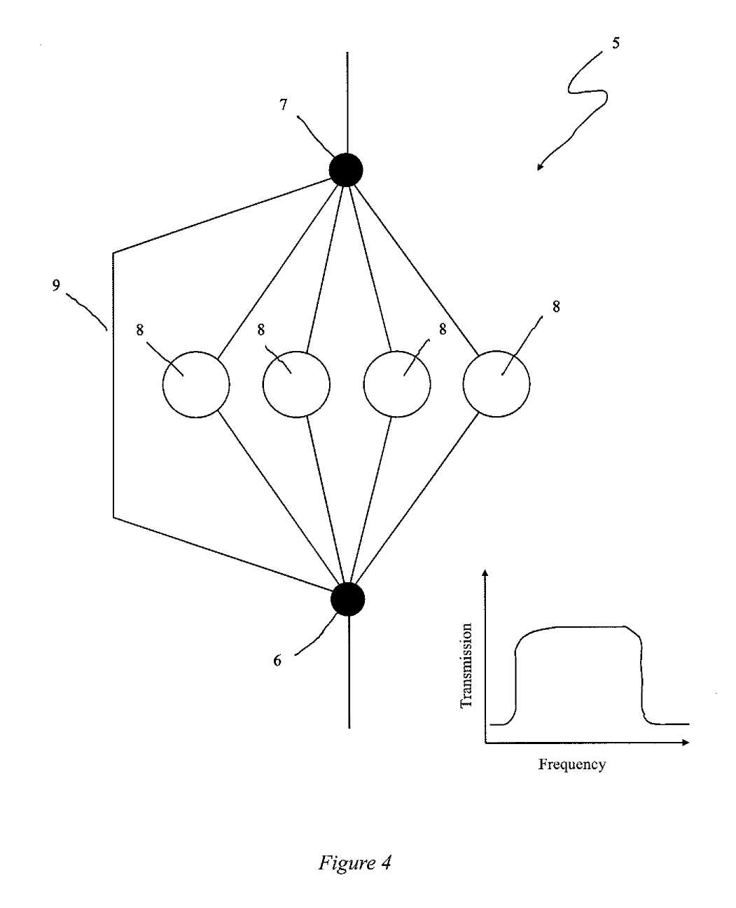

FIG. 4 shows a further embodiment of a filter according to the invention;

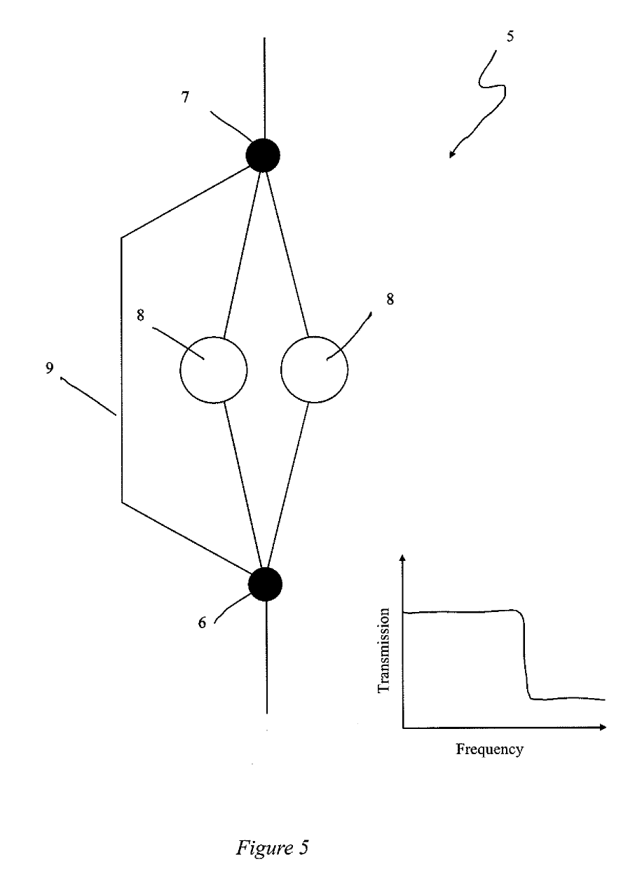

FIG. 5 shows a further embodiment of a filter according to the invention;

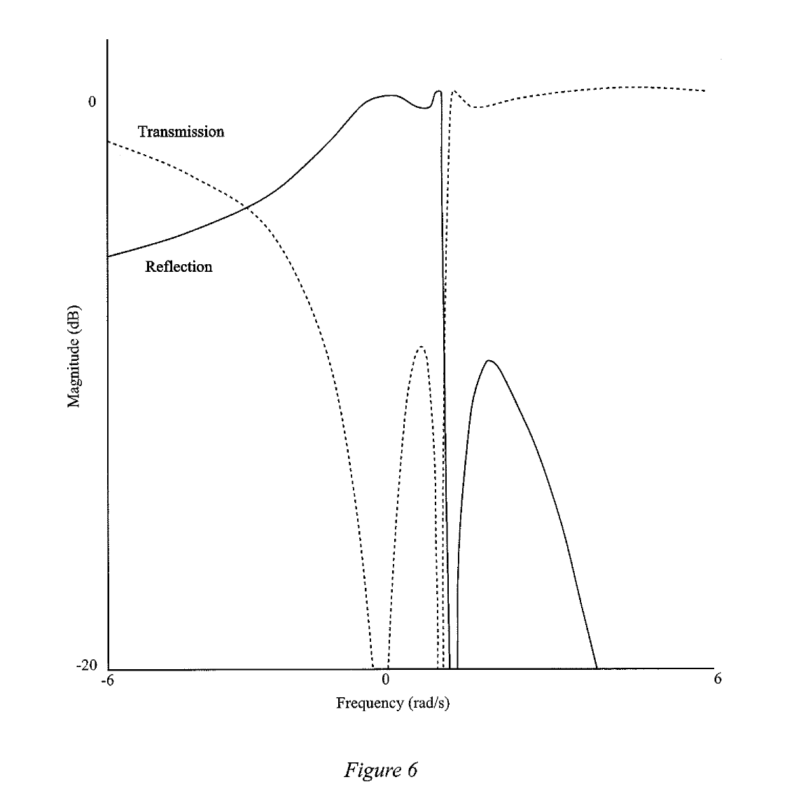

FIG. 6 shows the transmission and reflection of a filter according to the invention; and,

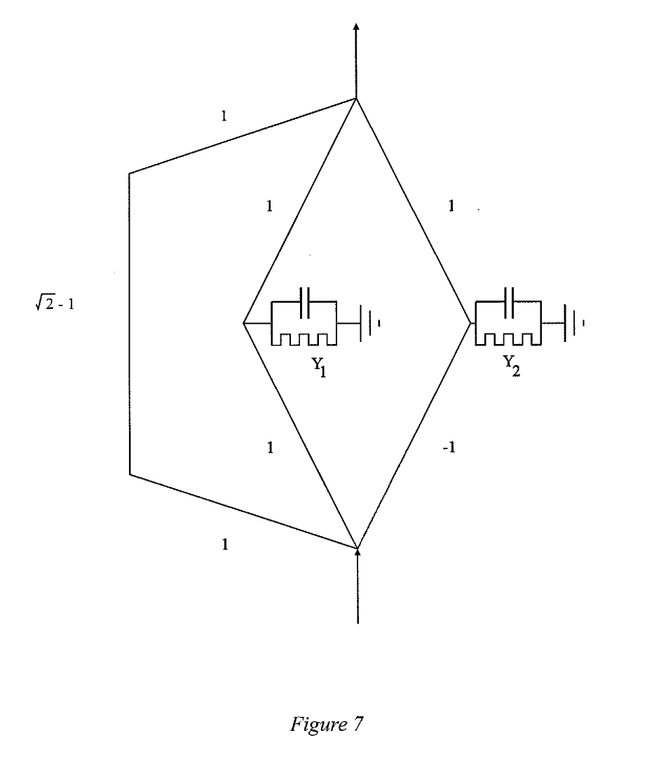

FIG. 7 shows an equivalent circuit for a filter according to the invention.

Shown in FIG. 1 is a known microwave filter 1. The filter 1 comprises a plurality of resonators 2 connected together in series. The resonators 2 have different resonant frequencies producing a composite filter having a passband. Each resonator 2 couples loss into the system. Accordingly, to meet typical rejection requirements each resonator 2 must be of high Q. This results in a filter 1 which is expensive to manufacture and which may be large and heavy.

A partial solution to this problem requiring only one high Q cavity per band edge is known. This solution comprises a reflection mode filter 3 connected to a circulator 4 as shown in FIG. 2. The limitation of this arrangement is that a circulator 4 is required. This has limited isolation and introduces additional loss.

Shown in FIG. 3 is a microwave filter 5 for filtering a microwave signal according to the invention. The filter 5 has a single band edge at a band edge transition frequency, so defining a passband. In this embodiment the filter 5 is either a high pass or low pass filter 5. The filter 5 comprises an input port 6 and an output port 7. Connected between the input port 6 and output port 7 in parallel is a plurality (in this case four) of single resonators 8. Also connected between the input port 6 and output port 7 in parallel with the resonators 8 is a frequency independent electrical coupling 9.

Each of the resonators 8 has a Q value. In this embodiment the Q value of one of the resonators 8 has a Q value which is at least four times that of the Q values of each of the other resonators 8.

The microwave filter 5 according to the invention has low loss over the entire passband, even though only one of the resonators 8 is a ‘high’ Q resonator 8, relative to the other resonators 8.

Shown in FIG. 4 is a further embodiment of a microwave filter 5 according to the invention. This embodiment comprises a filter 5 having two band edges defining a passband therebetween. Again, the filter 5 comprises four resonators 8 connected in parallel between the input and output ports 6,7. A frequency independent coupling 9 is connected in parallel with the resonators 8.

In this embodiment two of the resonators 8 are ‘high’ Q resonators 8, each of the resonators 8 having a Q value which is at least a factor of four larger than the Q values of the remaining resonators 8.

FIG. 5 shows a further embodiment of a microwave filter 5 according to the invention. In this embodiment the filter 5 has one band edge at a band edge transition frequency. The filter comprises two resonators 8 connected in parallel between input and output ports 6,7. A frequency independent coupling 9 also extends between the ports 6,7 in parallel with the resonators 8. In this embodiment one of the resonators 8 has a Q value which is a factor of five higher than that of the other resonator 8.

Generally speaking, it is preferred that a subset of the resonators 8 of filters 5 according to the invention have Q values which are each a factor of at least three larger than the Q values of the remaining resonators 8. More preferably the Q values are a factor of four, more preferably a factor of five larger than the Q values of the remaining resonators 8. It is preferred that the number of resonators 8 in this subset is equal to the number of band edges as shown in the examples above.

Shown in FIG. 6 is the reflection and transmission of a microwave filter according to the invention. The filter 5 is a lossless second degree filter 5 with a finite passband and infinite stopband designed with 10 dB return loss and 10 dB reflection. For this design the ration of the bandwidths for the two resonators 8 is close to 8:1.

The operation of such filters 5 according to the invention can be best explained by first explaining the behaviour of the simplest case, that of a second degree filter 5 having two resonators 8. For a quasi lossless filter |S₁₂(jw)|² is chosen to be

$${\vert S 12 \vert}^{2} = \frac{{( 1 - w )}^{4}}{{( 1 + w )}^{4} + {( 1 - w )}^{4}}$$

The stopband has a fourth ordered zero around w=1 and

$${\vert S 11 \vert}^{2} = \frac{{( 1 + w )}^{4}}{{( 1 + w )}^{4} + {( 1 - w )}^{4}}$$

And the passband has a fourth order zero around w=−1.

Factorising for S₁₂(p) and S₁₁(p) with p the complex frequency variable we have

$$S 12 ( p ) = \frac{{( p - j )}^{2}}{√ 2 ( {p}^{2} + 2 p \sqrt{2} + 1 )}$$

$$and , \\ S 11 ( p ) = \frac{{( p + j )}^{2}}{√ 2 ( {p}^{2} + 2 p \sqrt{2} + 1 )}$$

Since S₁₁(p) has both zeros on the p=jw axis then

S22(p)=S11(p)

and the network can be realised as a symmetrical structure and can be decomposed into even and odd mode admittances Yₑ(p) and Yₒ(p)

$${Y}_{e} = \frac{- j ( \sqrt{2} + 1 ) ( p + j )}{p - {j ( \sqrt{2} + 1 )}^{2}}$$

$${Y}_{O} = \frac{j ( \sqrt{2} + 1 ) ( p - {j ( \sqrt{2} - 1 )}^{2} )}{( p + j )}$$

$$Since$$

$${S}_{11} ( p ) = \frac{1 - {Y}_{e} {Y}_{O}}{( 1 + {Y}_{e} ) ( 1 + {Y}_{O} )}$$

$$and$$

$${S}_{12} ( p ) = \frac{{Y}_{e} - {Y}_{O}}{( 1 + {Y}_{e} ) ( 1 + {Y}_{O} )}$$

the partial fraction expansion of Yₑ and Yₒ yields

$${Y}_{e} ( p ) = - j ( \sqrt{2} + 1 ) + \frac{2 √ 2 {( \sqrt{2} + 1 )}^{2}}{p - {j ( \sqrt{2} + 1 )}^{2}}$$

$${Y}_{O} ( p ) = j ( \sqrt{2} + 1 ) + \frac{2 √ 2}{( p + j )}$$

One network realization is shown in FIG. 7 using impedance inverters. With

$${Y}_{1} = \frac{p - {j ( \sqrt{2} + 1 )}^{2}}{√ 2 {( \sqrt{2} + 1 )}^{2}}$$

$${Y}_{2} = \frac{p + j}{√ 2}$$

The admittance of the resonator Y₂ at the reflection zero w=−1 is 1/√2 whereas the admittance of the resonator Y₁ at a zero w=(√2+1)², a considerable distance from a transition band, is 1/√2(√2+1)², a factor (√2−1)² smaller than that of Y₂.

Hence, if Y₂ is realised using a high Q resonator and Y₁ using a low Q resonator then to have a similar effect on loss the low Q resonator can have a Q factor which is (√2−1)² less than the high Q resonator. In other words, provided the high Q resonator has Q value which is a factor of the order (√2+1)² higher than the low Q resonator then the loss of the filter is substantially determined by that of the high Q filter only.

For high degree networks with the most general form of the transfer characteristic, the even and odd mode admittances can always be formed and expressed as partial fraction expansions of the form

$${Y}_{e} ( p ) = {jK}_{e} + {\sum }_{r = 1}^{{N}_{e}} \frac{{A}_{er}}{p + {jw}_{er}}$$

$${Y}_{O} ( p ) = {jk}_{O} + {\sum }_{r = 1}^{{N}_{O}} \frac{{A}_{or}}{p + {jw}_{or}}$$

where Yₑ and Yₒ are within one degree of each other and the residues Aₑᵣ, A_{cr} are always positive and real. The realization is achieved by the parallel connection of resonators 8 for the even mode and odd mode cases with effectively a 1:−1 transformer identifying the difference between the even and odd mode networks. In this realization there is always one mode which is much smaller than the rest.

1. A microwave filter for filtering a microwave signal, the microwave filter having at least one band edge at a band edge transition frequency, the filter comprising:
an input port;
an output port; and,
a plurality of single resonators connected in parallel between the input and output ports;
a frequency independent electrical coupling between the input and output ports connected in parallel with the resonators;
a subset of the resonators having Q values each of which are at least a factor of three higher than the Qs of each of the remaining resonators.

2. A microwave filter as claimed in claim 1, wherein the number of resonators in the subset is equal to the number of band edges.

3. A microwave filter as claimed in claim 1, wherein the Q values of the resonators in the subset are at least four times that of the Qs of each of the remaining resonators.

4. A microwave filter as claimed in claim 1, having one band edge.

5. A microwave filter as claimed in claim 4, comprising two resonators in parallel.

6. A microwave filter as claimed in claim 1, comprising at least three resonators in parallel.

7. A microwave filter as claimed in claim 1, wherein at least one resonator comprises a cavity resonator.

8. A microwave filter as claimed in claim 1, comprising at least one impendence inverter.

9. A microwave filter as claimed in claim 1, further comprising an electrical signal generator connected to the input port.

10. (canceled)

11. (canceled)

12. A microwave filter as claimed in claim 3, wherein the Q values of the resonators in the subset are at least five times that of the Qs of each of the remaining resonators.

13. A microwave filter as claimed in claim 6, comprising at least four resonators in parallel.
